(19) United States
(12) Patent Application Publication
(10) Pub. No.: US 2025/0032337 A1
(43) Pub. Date: Jan. 30, 2025

(54) EXERCISE CHAIR AND LOWER EXTREMITY EXERCISE SYSTEM

(71) Applicant: TOYOTA JIDOSHA KABUSHIKI KAISHA, Toyota-shi (JP)

(72) Inventors: Eisuke AOKI, Toyota-shi (JP); Tomio Ikeda, Toyota-shi (JP)

(73) Assignee: TOYOTA JIDOSHA KABUSHIKI KAISHA, Toyota-shi (JP)

(21) Appl. No.: 18/754,744

(22) Filed: Jun. 26, 2024

(30) Foreign Application Priority Data
Jul. 24, 2023 (JP) 2023-119608

(51) Int. Cl. A61G 15/00; A61G 15/12; A63B 22/06

(52) U.S. Cl. CPC A61G 15/007; A61G 15/12; A63B 22/0694; A63B 2022/0641; A63B 2022/0652

(57) ABSTRACT

An exercise chair allows a user to perform a lower extremity exercise in a sitting position. The exercise chair includes: a seating portion configured to allow the user to sit on; a backrest configured to support the back of the user; and a support mechanism configured to support the backrest. The support mechanism is configured to support the backrest so as to allow the backrest to reciprocate to right and left and to rotate in roll.

### CROSS-REFERENCE TO RELATED APPLICATION

This application claims priority to Japanese Patent Application No. 2023-119608 filed on Jul. 24, 2023, incorporated herein by reference in its entirety.

### BACKGROUND

### 1. Technical Field

The present disclosure relates to exercise chairs and lower extremity exercise systems.

### 2. Description of Related Art

Moderate exercise is essential to maintain health. However, in order to exercise regularly, it is necessary to regularly make time for it. For this reason, busy people tend to lack exercise. However, even if it is difficult to regularly make time for exercise, just exercising lower extremities, even in a sitting position, will still achieve a certain level of exercise. A pedal exercise device is known as a lower extremity exercise device that allows to exercise lower extremities in a sitting position. In order to enhance the benefits from seated lower extremity exercise, the inventors focused on the kinetic chain between the lower extremities and the trunk. First, activating this kinetic chain will reduce waist size. Second, activating this kinetic chain will strengthen the rectus abdominis, transversus abdominis, and erector spinae, making it easier to maintain a posture with an anterior tilted pelvis. This will help fix hunchback and text neck. Third, achieving the kinetic chain between the lower extremities and the trunk will improve the flexibility of the iliopsoas due to constant movement of the pelvis, which will improve chronic lower back pain.

The inventors reported the following in Japanese Unexamined Patent Application Publication No. 2023-5485 (JP 2023-5485 A). When the user exercises his or her lower extremities in a sitting position, the user's pelvis moves less if the seat portion is fixed, which hinders the kinetic chain between the lower extremities and the trunk. Intentionally making the seating portion unstable allows the user to activate the kinetic chain between the lower extremities and the trunk.

Specifically, JP 2023-5485 A discloses a pedal exercise system including a chair with a seating portion on which a user sits and a pedal exercise device for performing a pedaling exercise while sitting on the seating portion. The seat portion is allowed to rotate in at least one of roll, pitch, and yaw. Intentionally making the seat portion unstable in this manner allows the user sitting on the seat portion to activate the kinetic chain between the lower extremities and the trunk. JP 2023-5485 A also describes that fastening the user's trunk to the backrest with a belt can effectively reduce unnecessary movement of the user's head and arms.

### SUMMARY

While experimenting pedaling exercises using the chair described in JP 2023-5485 A, it was found that there were two types of users: A and B. Type A users perform a pedaling exercise using a descending kinetic chain from their trunk to lower extremities while swaying their trunk to the right and left. Type B users perform a pedaling exercise while rotating their thoracic vertebrae, lumbar vertebrae, and hip joints in yaw about the midline of their trunk.

If the type A users perform a pedaling exercise while sitting on the chair of JP 2023-5485 A, there is a concern that they are unable to effectively sway their trunk to the right and left and therefore substantially unable to perform a pedaling exercise.

The present disclosure provides a technology that allows to perform a lower extremity exercise in a sitting position while swaying the trunk to the right and left.

A first aspect of the present disclosure is an exercise chair that allows a user to perform a lower extremity exercise in a sitting position. The exercise chair includes: a seating portion configured to allow the user to sit on; a backrest configured to support a back of the user; and a support mechanism configured to support the backrest. The support mechanism is configured to support the backrest so as to allow the backrest to reciprocate to right and left and to rotate in roll. According to the above configuration, it is possible to perform a lower extremity exercise in a sitting position while swaying a trunk to right and left.

In the exercise chair according to the above aspect, an axis of roll rotation of the backrest may be set to pass through either a midpoint of a line segment connecting two shoulder blades or a fourth thoracic vertebra of the user sitting on the seating portion. The above configuration improves the ability of the backrest to follow the trunk.
In the exercise chair according to the above aspect, the seating portion may be allowed to rotate in roll. According to the above configuration, a kinetic chain from the trunk to the lower extremities can be efficiently achieved.
In the exercise chair according to the above aspect, the seating portion may be allowed to reciprocate to right and left. According to the above configuration, the kinetic chain from the trunk to the lower extremities can be efficiently achieved.
In the exercise chair according to the above aspect, the seating portion may not be allowed to rotate in yaw. According to the above configuration, the kinetic chain from the trunk to the lower extremities can be efficiently achieved.
In the exercise chair according to the above aspect, the exercise chair may further include a restraint device configured to restrain the trunk of the user to the backrest. According to the above configuration, a misalignment between the trunk and the backrest can be reduced or prevented.
In the exercise chair according to the above aspect, the support mechanism may include a restoring device configured to return the backrest to a neutral position. According to the above configuration, the misalignment between the trunk and the backrest can be easily eliminated.
A second aspect of the present disclosure is a lower extremity exercise system including the above exercise chair and a lower extremity exercise device. According to the above configuration, it is possible to perform a lower extremity exercise in a sitting position while swaying the trunk to the right and left.
In the lower extremity exercise system according to the above aspect, the lower extremity exercise device may be an exercise device configured to at least apply a load for extension and flexion exercises of hip and knee joints of the user. With the above configuration, the user can efficiently perform a lower extremity exercise.
In the lower extremity exercise system according to the above aspect, the lower extremity exercise device may be a pedal exercise device or a stepper exercise device. With the above configuration, the user can efficiently perform a lower extremity exercise.

According to the present disclosure, it is possible to perform a lower extremity exercise in a sitting position while swaying the trunk to the right and left.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a lower extremity exercise system according to a first embodiment;

FIG. 2 is a side view of the lower extremity exercise system according to the first embodiment;

FIG. 3 is a front view of the lower extremity exercise system according to the first embodiment;

FIG. 4 is a back view of the lower extremity exercise system according to the first embodiment;

FIG. 5 is a front view of a seating unit according to the first embodiment;

FIG. 6 is a perspective view of a support mechanism according to the first embodiment; and

FIG. 7 is a front view of a lower extremity exercise system according to a second embodiment.

### DETAILED DESCRIPTION OF EMBODIMENTS

### First Embodiment

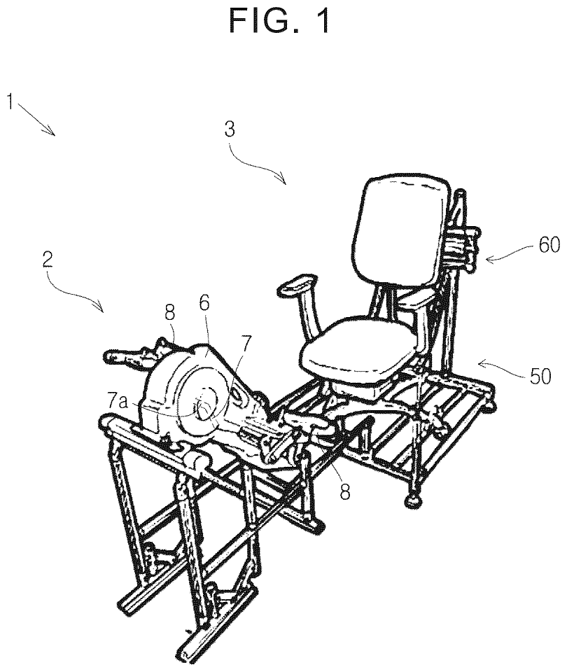

A first embodiment of the present disclosure will be described with reference to FIGS. 1 to 6. FIGS. 1 to 4 shows a lower extremity exercise system 1. As shown in FIG. 1, the lower extremity exercise system 1 includes a pedal exercise device 2 and an exercise chair 3.

### Pedal Exercise Device 2

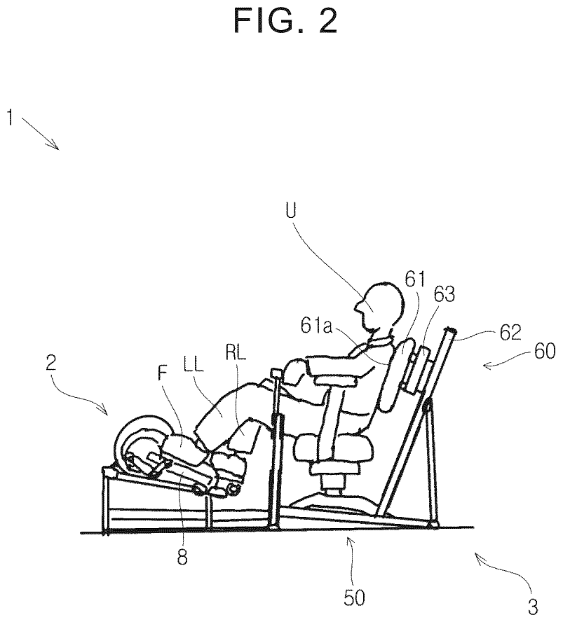

As shown in FIGS. 2 to 4, the pedal exercise device 2 is an example of a lower extremity exercise device that allows a user U to perform a pedaling exercise in a sitting position. The pedal exercise device 2 is a specific example of a lower extremity exercise device that allows to perform a lower extremity exercise involving repetitive extension and flexion of knee joints, hip joints, and ankle joints. As shown in FIG. 1, the pedal exercise device 2 includes a device body 6, a pair of cranks 7, and a pair of pedals 8. The pedals 8 are mounted on the cranks 7 so as to be rotatable in pitch. The cranks 7 are mounted on the device body 6 as to be rotatable in pitch. As shown in FIG. 2, the user U sitting on the exercise chair 3 places his or her both feet F on the pedals 8 and performs a so-called pedaling exercise. Namely, the user U alternately pushes the pedals 8 around with his or her right and left legs RL, LL. At this time, the knee joints, hip joints, and ankle joints of the right and left legs RL, LL are repeatedly extended and flexed. Typically, when the knee joint of the right leg RL is extended, the knee joint of the left leg LL is flexed. When the hip joint of the right leg RL is extended, the hip joint of the left leg LL is flexed. When the ankle joint of the right leg RL is extended, the ankle joint of the left leg LL is flexed. The pedals 8 are thus rotated about a crankshaft 7a shown in FIG. 1 in opposite phases. That is, the pedal exercise device 2 allows to perform a lower extremity exercise in which both feet F follow an elliptical trajectory about the crankshaft 7a. The device body 6 is configured to adjust the load against rotation of the crankshaft 7a. The user U can perform a pedaling exercise with a desired load by adjusting the load against rotation of the crankshaft 7a.

The pedal exercise device 2 is merely an example of the lower extremity exercise device. The lower extremity exercise device may be any exercise device that at least applies a load alternately to the right and left legs for extension and flexion of the hip joints and knee joints of the user U. An example of the lower extremity exercise device, other than the pedal exercise device 2, is a stepper exercise device. Pedaling exercise and stepping exercise are specific examples of a lower extremity exercise.

### Exercise Chair 3

The exercise chair 3 is a chair on which the user U sits for pedaling exercise. In the present embodiment, the exercise chair 3 is a separate device from the pedal exercise device 2. The distance between the pedal exercise device 2 and the exercise chair 3 is therefore adjustable. However, the exercise chair 3 and the pedal exercise device 2 may be a single-piece device.

As shown in FIGS. 1 and 2, the exercise chair 3 includes a seating unit 50 and a backrest unit 60.

### Seating Unit 50

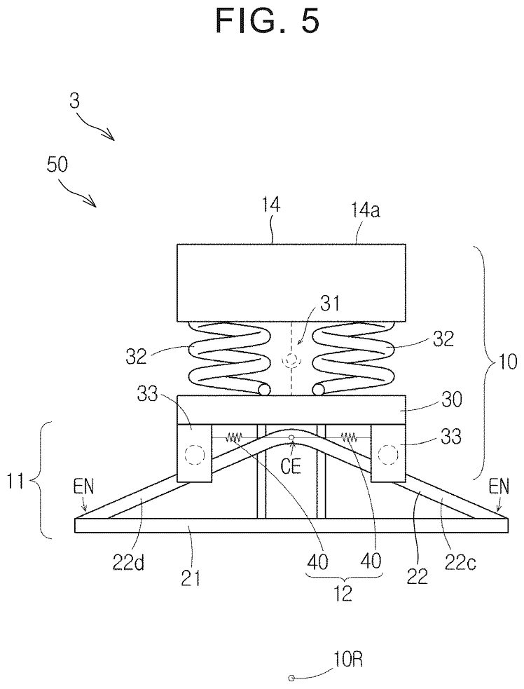

As shown in FIG. 5, the seating unit 50 includes a movable portion 10, a support portion 11, and a restoring unit 12.

The movable portion 10 includes a seating portion 14 on which the user U sits.

The support portion 11 supports the movable portion 10 so that the movable portion 10 is movable to the right and left. As used herein, “right and left” is defined as right and left as viewed from the user U sitting on the seating portion 14. Similarly, “front and back” is defined as front and back as viewed from the user U sitting on the seating portion 14.

The restoring unit 12 biases the movable portion 10 toward a neutral position in the right-left direction. In FIG. 5, the movable portion 10 is at the neutral position. The neutral position is a specific example of a reference position. When the movable portion 10 on which the user U is sitting is at the neutral position, the right and left hip joints of the user U are located at the same height. The support portion 11 guides the movable portion 10 so that the movable portion 10 lowers as the movable portion 10 moves away from the neutral position to the right or left. Specifically, when the movable portion 10 moves away from the neutral position to the right, the right hip joint of the user U is located lower than the left hip joint of the user U. When the movable portion 10 moves away from the neutral position to the left, the right hip joint of the user U is located higher than the left hip joint of the user U. As described above, the difference in height is produced between the right and left hip joints of the user U when the movable portion 10 moves away from the neutral position to the right and left. It can therefore be said that the movable portion 10 rotates in roll.

The user U performs a pedaling exercise with the pedal exercise device 2 while sitting on the seating portion 14 of the exercise chair 3. Since the movable portion 10 is configured to rotate in roll, an efficient kinetic chain between the lower extremities and the trunk occurs when the user U performs a pedaling exercise with the pedal exercise device 2 while sitting on the seating portion 14 of the exercise chair 3.

### Support Portion 11

The support portion 11 is fixedly installed on the floor surface. The support portion 11 includes a seating frame 21 and two rails 22. Since the two rails 22 are arranged in a direction perpendicular to the plane of paper of FIG. 5, only one of the two rails 22 is shown in FIG. 5.

The seating frame 21 is a portion that contacts the floor surface on which the exercise chair 3 is installed. The seating frame 21 supports the two rails 22.

The two rails 22 define a trajectory of movement of the movable portion 10 to the right and left. As described above, the two rails 22 are disposed apart from each other in the front-back direction. Each rail 22 curves downward. In other words, each rail 22 is tilted downward from the middle CE in the longitudinal direction of the rail 22 toward ends EN of the rail 22. Each rail 22 is tilted downward from the middle CE in the longitudinal direction of the rail 22 such that the ends EN of the rail 22 are located closest to the floor surface. In the present embodiment, each rail 22 is formed in a V-shape that curves downward (in other words, the protruding portion of the V-shape is positioned above) and opens downward. Therefore, when the movable portion 10 moves to the right or left along the two rails 22, the movable portion 10 is guided so as to lower as it moves away from the neutral position. In other words, the support portion 11 supports the movable portion 10 so that the movable portion 10 swings to the right and left about a roll axis 10R extending in the front-back direction, that is, so that the movable portion 10 rotates in roll about the roll axis 10R. The roll axis 10R is set below the position of the movable portion 10 when the movable portion 10 is at the neutral position. When the movable portion 10 moves to the right or left along the two rails 22, the movable portion 10 is guided so that the center of gravity of the movable portion 10 is lowered as the movable portion 10 moves away from the neutral position. Each rail 22 includes a left rail portion 22c extending leftward from the middle in the longitudinal direction of the rail 22, and a right rail portion 22d extending rightward from the middle in the longitudinal direction of the rail 22.

In the present embodiment, each rail 22 has a V-shape that curves downward and opens downward. However, the shape of each rail 22 is not limited to this. Each rail 22 may have a U-shape that curves downward (in other words, the curved portion of the U-shape is positioned above) and opens downward. Each rail 22 may have a curved shape that curves downward and opens downward. Each rail 22 may typically extend in the shape of a circular or elliptical arc that curves downward and opens downward.

In the present embodiment, the right and left rail portions 22d, 22c of each rail 22 are provided as a single-piece member. Alternatively, the right and left rail portions 22d, 22c may be separate members and may be disposed apart from each other.

### Movable Portion 10

The movable portion 10 will be described with reference to FIG. 5. As shown in FIG. 5, the movable portion 10 includes a movable portion body 30, the seating portion 14, a universal joint 31, two coil springs 32, and two coupling portions 33.

The seating portion 14 is typically made of a material with cushioning properties, such as a material with an open cell structure like urethane foam.

The two coupling portions 33, the movable portion body 30, and the seating portion 14 are arranged in this order in a direction away from the floor surface. The universal joint 31 and the two coil springs 32 are disposed between the movable portion body 30 and the seating portion 14.

The movable portion body 30 is a plate interposed between the support

portion 11 and the seating portion 14. The two coupling portions 33 are located on the lower surface of the movable portion body 30. One of the two coupling portions 33 is slidably coupled to the left rail portion 22c, and the other is slidably coupled to the right rail portion 22d. Each coupling portion 33 may include a wheel, as shown by a dashed line, that rolls on a corresponding rail, and a bracket that rotatably holds the wheel.

The seating portion 14 and the movable portion body 30 are coupled by the universal joint 31. The seating portion 14 is thus supported by the movable portion body 30 so as to be tiltable forward and backward with respect to the movable portion body 30. That is, the seating portion 14 is allowed to rotate in pitch. Pitch rotation means rotation about a pitch axis. The “pitch axis” herein means an axis extending in the right-left direction. The pitch axis passes through the universal joint 31. Therefore, the pitch axis is set below the seating portion 14. Similarly, the seating portion 14 is supported by the movable portion body 30 so as to be tiltable right and left with respect to the movable portion body 30. That is, not only the movable portion body 30 and the support portion 11 allow the seating portion 14 to rotate in roll, but also the universal joint 31 allows the seating portion 14 to rotate in roll.

Roll rotation of the seating portion 14 by the universal joint 31 means rotation of the seating portion 14 about a roll axis passing through the universal joint 31. The “roll axis” herein means an axis extending in the front-back direction.

The two coil springs 32 are disposed between the seating portion 14 and the movable portion body 30. Each coil spring 32 has its upper end fixed to the seating portion 14 and its lower end fixed to the movable portion body 30. In the present embodiment, the two coil springs 32 are disposed to sandwich the universal joint 31 therebetween in the right-left direction. In other words, the two coil springs 32 are disposed apart from each other in the left-right direction. When the seating portion 14 makes a forward or backward pitch rotation with respect to the movable portion body 30, the two coil springs 32 bias the seating portion 14 so as to return the seating portion 14 to the state before the pitch rotation. Similarly, when the seating portion 14 makes a rightward or leftward roll rotation with respect to the movable portion body 30, the two coil springs 32 bias the seating portion 14 so as to return the seating portion 14 to the state before the roll rotation. Since the two coil springs 32 are disposed apart from each other, yaw rotation of the seating portion 14 with respect to the movable portion body 30 is prohibited. In short, the seating portion 14 is not allowed to rotate in yaw. The “yaw axis” herein means an axis extending in a vertical direction that is a direction in which gravity acts. Alternatively, the “yaw axis” may be an axis extending in the thickness direction of the movable portion body 30. Alternatively, the “yaw axis” may be an axis perpendicular to a seating surface 14a of the seating portion 14.

The user U sits on the seating surface 14a of the seating portion 14. The seating surface 14a of the seating portion 14 faces the buttocks of the user U. The seating surface 14a is tilted backward so as to allow the pelvis of the user U to be tilted posteriorly when the user U sits on the seating portion 14. That is, the front part of the seating surface 14a is located higher than the rear part thereof. Therefore, the user U is supported by the seating surface 14a and a backrest 61 of the backrest unit 60 that will be described later.

### Restoring Unit 12

The restoring unit 12 is a specific example of a biasing device. The restoring unit 12 biases the movable portion 10 toward the neutral position in the right-left direction. In the present embodiment, the restoring unit 12 is an elastic element. That is, the restoring unit 12 includes a pair of restoring coil springs 40. The restoring coil springs 40 are placed between the middle CE of each rail 22 and the coupling portions 33. When the movable portion 10 moves to the left, the left restoring coil spring 40 expands, and the elastic restoring force of the left restoring coil spring 40 biases the movable portion 10 toward the neutral position. Similarly, when the movable portion 10 moves to the right, the right restoring coil spring 40 expands, and the elastic restoring force of the right restoring coil spring 40 biases the movable portion 10 toward the neutral position.

In the present embodiment, the elastic clement constituting the restoring unit 12 is a coil spring. However, other elastic elements such as rubber may be used instead of the coil spring.

In the present embodiment, the restoring unit 12 is composed of the pair of restoring coil springs 40. However, the restoring unit 12 may be composed of one coil spring. In this case, typically, one coil spring is placed between the coupling portions 33 and is fixed to the middle CE at the middle in the longitudinal direction of the coil spring. The restoring unit 12 may be placed between the seating frame 21 and the movable portion 10 instead of between the rails 22 and the movable portion 10.

With the above configuration, when the user U pushes the pedal 8 with his or her left foot, his or her pelvis moves slightly to the left, so that the movable portion body 30 moves slightly to the left accordingly. Since each rail 22 is tilted so as to lower from the middle CE toward the ends EN, this leftward movement of the movable portion body 30 is amplified, which increases the amount of movement of the pelvis. Since the amount of movement of the pelvis is large, the trunk muscles of the user U are activated with the pushing motion of the lower legs of the user U. As a result, exercise of the trunk muscles is achieved. The same applies when user U pushes the pedal 8 with his or her right foot.

The reason why the restoring unit 12 is provided will be described. If the restoring unit 12 were omitted, it would be difficult to return the movable portion 10 to the neutral position once the movable portion 10 moves to the right or left from the neutral position. Specifically, even if the user U can momentarily remove the load on the movable portion 10, it is difficult for the user U to return the movable portion 10 to the neutral position at that timing. However, with the restoring unit 12, the movable portion 10 is biased toward the neutral position if the user U just momentarily removes the load on the movable portion 10. The movable portion 10 can therefore be easily returned to the neutral position using the inertia generated when the movable portion 10 is biased. It is preferable that the elastic restoring force of the restoring unit 12 be adjustable according to the physique and muscle strength of the user U. That is, when the user U who does not know well how to use the trunk muscles uses the exercise chair 3, the spring constant of the restoring unit 12 may be set high so that the movable portion 10 actively returns to the neutral position. On the other hand, when the user U who knows well how to use the trunk muscles uses the exercise chair 3, the spring constant of the restoring unit 12 may be set low. When the spring constant of the restoring unit 12 is low, the movable portion 10 less actively returns to the neutral position. Therefore, activation of the trunk muscles will be required every time the user U returns the movable portion 10 to the neutral position. The load on the trunk muscles can thus be adjusted by changing the spring constant of the restoring unit 12. The restoring unit 12 may be omitted depending on the skill level of the user U.

In the present embodiment, when the movable portion 10 moves to the right, the seating surface 14a of the seating portion 14 is tilted to the right. Similarly, when the movable portion 10 moves to the left, the seating surface 14a of the seating portion 14 is tilted to the left. The tilt angle of the seating surface 14a at this time does not necessarily match the natural tilt angle of the pelvis. In the present embodiment, the seating portion 14 is allowed to rotate in roll with respect to the movable portion body 30 by the universal joint 31. Therefore, the tilt angle of the seating surface 14a of the seating portion 14 follows the natural tilt angle of the pelvis of the user U. Accordingly, sitting comfort of the seating portion 14 during exercise will not be impaired.

### Backrest Unit 60

Next, the backrest unit 60 will be described. As shown in FIG. 2, the backrest unit 60 includes the backrest 61, a backrest frame 62, and a support mechanism 63.

The backrest 61 supports the trunk, specifically the back, of the user U sitting on the seating unit 50. The backrest 61 is typically made of a material with cushioning properties, such as a material with an open cell structure like urethane foam. The surface of the backrest 61 is covered with a material that provides high frictional resistance to the user U, such as a polyurethane sheet or a rubber sheet. The backrest 61 is tilted backward. Therefore, the seating surface 14a of the seating portion 14 and a contact surface 61a of the backrest 61 form a V-shape that opens upward.

The backrest frame 62 extends obliquely backward from the floor surface on which the exercise chair 3 is installed. The backrest frame 62 is connected to the seating frame 21 of the seating unit 50 shown in FIG. 5.

Referring back to FIG. 2, the support mechanism 63 is provided between the backrest 61 and the backrest frame 62. The support mechanism 63 supports the backrest 61 so as to allow the backrest 61 to reciprocate to the right and left and to rotate in roll. Specifically, the support mechanism 63 supports the backrest 61 in such a manner that the backrest 61 can reciprocate to the right and left with respect to the backrest frame 62 and can rotate in roll with respect to the backrest frame 62.

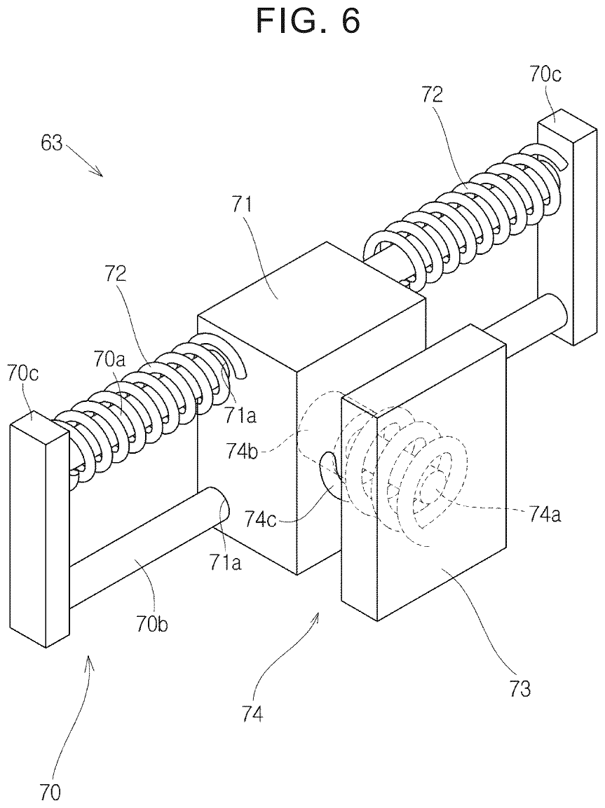

FIG. 6 is a perspective view of the support mechanism 63. As shown in FIG. 6, the support mechanism 63 includes a horizontal guide portion 70, a guide bracket 71, two compression coil springs 72, a fixed plate 73, and a connection unit 74.

The horizontal guide portion 70 includes an upper horizontal guide bar 70a, a lower horizontal guide bar 70b, and two guide bar connection portions 70c. The upper and lower horizontal guide bars 70a, 70b are disposed apart from each other in the up-down direction, and the guide bar connection portions 70c connect the ends of the upper and lower horizontal guide bars 70a, 70b. Both of the upper and lower horizontal guide bars 70a, 70b extend in the horizontal direction. The horizontal guide portion 70 is fixed to the backrest frame 62 shown in FIG. 2.

Referring back to FIG. 6, the guide bracket 71 has two through holes 71a through which the upper and lower horizontal guide bars 70a, 70b extend. Both of the two through holes 71a extend in the horizontal direction. The guide bracket 71 is supported by the horizontal guide portion 70 in such a manner that the guide bracket 71 can reciprocate in the right-left direction.

The two compression coil springs 72 are disposed between the guide bracket 71 and the two guide bar connection portions 70c. The two compression coil springs 72 have the same natural length and the same spring constant. As shown in FIG. 6, when the guide bracket 71 is at a neutral position, the two compression coil springs 72 are compressed to about the same extent. The guide bracket 71 being at the neutral position means that the guide bracket 71 is located in the middle in the longitudinal direction of the upper horizontal guide bar 70a. When the guide bracket 71 moves horizontally to the right from this state, the right compression coil spring 72 is further compressed, and the guide bracket 71 is biased toward the neutral position by the spring restoring force of the right compression coil spring 72. The same applies when the guide bracket 71 moves horizontally to the left.

The two compression coil springs 72 are typically mounted on the upper horizontal guide bar 70a. In this case, the helix axes of the two compression coil springs 72 coincide with the central axis of the upper horizontal guide bar 70a. The two compression coil springs 72 may alternatively be mounted on the lower horizontal guide bar 70b. The two compression coil springs 72 are a specific example of a restoring device that returns the backrest 61 to the neutral position. The restoring device that returns the backrest 61 to the neutral position may be two rubber strings instead of the two compression coil springs 72. In this case, the two rubber strings are disposed so as to connect the guide bracket 71 and the two guide bar connection portions 70c.

The fixed plate 73 is fixed to the back surface of the backrest 61. The fixed plate 73 is typically disposed so as to face the guide bracket 71 in a direction perpendicular to the contact surface 61a of the backrest 61 shown in FIG. 2.

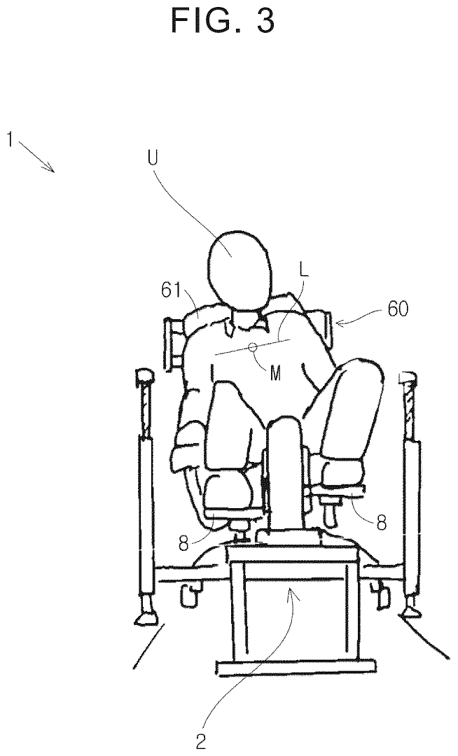

Referring back to FIG. 6, the connection unit 74 connects the guide bracket 71 and the fixed plate 73. The connection unit 74 connects the guide bracket 71 and the fixed plate 73 so as to allow the fixed plate 73 to rotate in roll with respect to the guide bracket 71. Specifically, the connection unit 74 includes a shaft 74a, a bearing 74b, and a torsion spring 74c. The shaft 74a is fixed to the fixed plate 73 so as to protrude from the fixed plate 73 toward the guide bracket 71. The bearing 74b is mounted in the guide bracket 71 and rotatably supports the shaft 74a. The fixed plate 73 is thus allowed to rotate in roll with respect to the guide bracket 71. The axis of roll rotation of the fixed plate 73 extends in the direction in which the fixed plate 73 and the guide bracket 71 face each other. This axis of roll rotation extends in the direction perpendicular to the contact surface 61a of the backrest 61 shown in FIG. 2. As shown in FIG. 3, this axis of roll rotation may be set to pass through a midpoint M of a line segment L connecting two shoulder blades of the user U sitting on the seating portion 14. Alternatively, this axis of roll rotation may be set to pass through the pit of the stomach or fourth thoracic vertebra of the user U sitting on the seating portion 14.

Referring back to FIG. 6, the torsion spring 74c is mounted around the shaft 74a. The torsion spring 74c has its one end fixed to the fixed plate 73 and the other end fixed to the guide bracket 71. Accordingly, when the fixed plate 73 rotates in roll clockwise relative to the guide bracket 71 from the state shown in FIG. 6, the fixed plate 73 is biased counterclockwise by the spring restoring force of the torsion spring 74c. In this sense, it can be said that the torsion spring 74c is a specific example of a restoring device that returns the backrest 61 to a neutral position in the roll position. The backrest 61 being at the neutral position in the roll direction means that the longitudinal direction of the backrest 61 is not tilted to the right or left as viewed from the front. It can be said that the backrest 61 is at the neutral position in the roll direction when the torsion spring 74c is under no load.

With the above configuration, as shown in FIG. 3, the user U sitting on the seating portion 14 starts to push the pedal 8 with his or her right leg RL by moving his or her trunk to the right while pressing his or her back against the backrest 61. That is, the movement of the trunk supported by the backrest 61 causes the trunk to move to the right. At this time, the backrest 61 also moves horizontally to the right together with the guide bracket 71, fixed plate 73, and connection unit 74 shown in FIG. 6. As shown in FIG. 3, the trunk of the user U is tilted to the right at this time. The backrest 61 rotates in roll counterclockwise together with the fixed plate 73 shown in FIG. 6 so as to follow this tilt. In this way, the backrest 61 can follow the trunk's horizontal movement and tilt to the right when the user U moves his or her trunk to the right or left. The user U can thus perform a pedaling exercise while keeping his or her trunk in close contact with the backrest 61, that is, while pressing his or her trunk against the backrest 61.

When the user U performs a pedaling exercise while pressing his or her trunk against the backrest 61, a misalignment will inevitably occur between the backrest 61 and the trunk. In this regard, in the present embodiment, the two compression coil springs 72 shown in FIG. 6 bias the backrest 61 so as to return the backrest 61 to the neutral position in the right-left direction, and the torsion spring 74c biases the backrest 61 so as to return the fixed plate 73 to the neutral position in the roll direction. Therefore, in order for the user U to eliminate the misalignment, the user U should once move his or her trunk away from the backrest 61. This allows the backrest 61 to automatically return to the neutral position in the right-left direction and the neutral position in the roll direction. The user U therefore need only press his or her trunk against the backrest 61 again after that. As described above, in the present embodiment, the backrest 61 returns to the neutral position in the right-left direction and the neutral position in the roll direction simply by the user U moving his or her trunk away from the backrest 61. The above misalignment can be very easily eliminated.

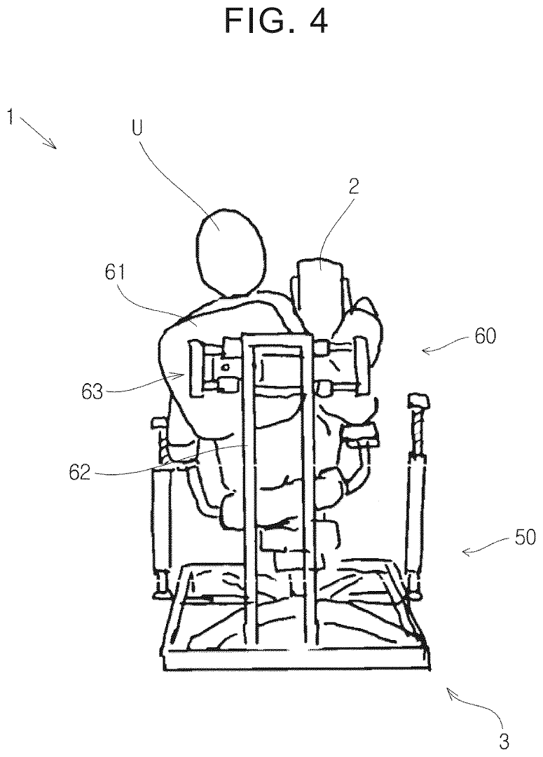

FIG. 4 shows the state in which the user U sitting on the seating portion 14 has moved his or her trunk to the left while pressing his or her back against the backrest 61. When the user U moves his or her trunk to the left, the backrest 61 can similarly follow the trunk of the user well.

The first embodiment of the present disclosure is described above. The first embodiment has the following features.

As shown in FIGS. 1 to 6, the exercise chair 3 is an exercise chair 3 that allows the user U to perform a lower extremity exercise in a sitting position. The exercise chair 3 includes the seating portion 14 on which the user U can sit, the backrest 61 that supports the back of the user U, and the support mechanism 63 that supports the backrest 61. The support mechanism 63 supports the backrest 61 so as to allow the backrest 61 to reciprocate to the right and left and to rotate in roll. According to the above configuration, the user U can perform a lower extremity exercise in a sitting position while swaying his or her trunk to the right and left. A descending kinetic chain from the trunk to the lower extremities can thus be achieved.

As shown in FIG. 3, the axis of roll rotation of the backrest 61 (central axis of the shaft 74a) is set at the midpoint M of the line segment L connecting the two shoulder blades of the user U sitting on the seating portion 14. The above configuration improves the ability of the backrest 61 to follow the trunk. The user U who starts performing a lower extremity exercise by swaying his or her trunk to the right or left uses the midpoint M as a point of effort. According to the above configuration, when the user U moves the backrest 61 to the right and left, the force to move the backrest 61 is used to move the backrest 61 to the right and left without inducing roll rotation of the backrest 61.

As shown in FIG. 5, the seating portion 14 is allowed to rotate in roll. According to the above configuration, since the swaying movement of the trunk of the user U to the right and left is not hindered, the kinetic chain from the trunk to the lower extremities can be efficiently achieved.

As shown in FIG. 5, the seating portion 14 is allowed to reciprocate to the right and left. According to the above configuration, since the swaying movement of the trunk of the user U to the right and left is not hindered, the kinetic chain from the trunk to the lower extremities can be efficiently achieved.

The seating portion 14 is not allowed to rotate in yaw. In the kind of movement mainly involving a linked movement from the trunk to the lower extremities by moving the trunk to the right and left, the thoracic vertebrae, lumbar vertebrae, and hip joints work as one unit. A pedaling exercise is thus performed with the trunk swaying to the right and left. Since yaw rotation of the seating portion 14 would induce unintended body movements, it would be difficult to perform a pedaling exercise while keeping the body stable. According to the above configuration, the kinetic chain from the trunk to the lower extremities can be efficiently achieved.

The support mechanism 63 may include the two compression coil springs 72 (restoring device) that return the backrest 61 to the neutral position. According to the above configuration, the misalignment between the trunk and the backrest can be easily eliminated.

The lower extremity exercise system 1 includes the exercise chair 3 and the pedal exercise device 2 (lower extremity exercise device). According to the above configuration, it is possible to perform a lower extremity exercise in a sitting position while swaying the trunk to the right and left.

The pedal exercise device 2 is an exercise device that at least applies a load for extension and flexion of the hip joints and knee joints of the user U. With the above configuration, the user U can efficiently perform a lower extremity exercise.

The lower extremity exercise system 1 may include a stepper exercise device instead of the pedal exercise device 2. Whether the lower extremity exercise system 1 includes the pedal exercise device 2 or the lower extremity exercise system 1 includes the stepper pedal exercise device instead of the pedal exercise device 2, the user U alternately extends and flexes the right and left legs RL, LL. Therefore, a kinetic chain from the trunk to the lower extremities can be achieved, so that the user U can efficiently perform a lower extremity exercise.

### Second Embodiment

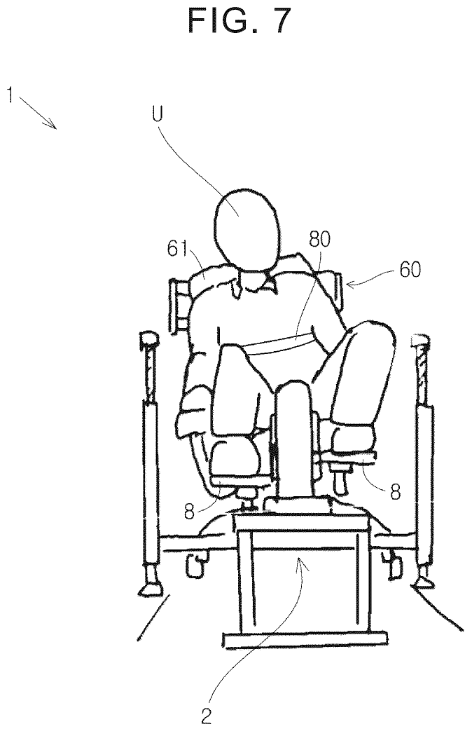

A second embodiment of the present disclosure will be described with reference to FIG. 7. The differences from the first embodiment will be mainly described, and repetitive description will be omitted.

In the first embodiment, in order to eliminate misalignment between the trunk of the user U and the backrest 61, the backrest unit 60 includes the two compression coil springs 72 and the torsion spring 74c, as shown in FIG. 6.

In the present embodiment, the two compression coil springs 72 and the torsion spring 74c may be omitted. In the present embodiment, the exercise chair 3 includes a restraint belt 80 that restrains the trunk of the user U to the backrest 61, as shown in FIG. 7. The restraint belt 80 is a specific example of a restraint device. Restraining the trunk of the user U to the backrest 61 with the restraint belt 80 can prevent or reduce misalignment between the trunk of the user U and the backrest 61.

What is claimed is:

1. An exercise chair that allows a user to perform a lower extremity exercise in a sitting position, the exercise chair comprising:
a seating portion configured to allow the user to sit on;
a backrest configured to support a back of the user; and
a support mechanism configured to support the backrest, wherein the support mechanism is configured to support the backrest so as to allow the backrest to reciprocate to right and left and to rotate in roll.

2. The exercise chair according to claim 1, wherein an axis of roll rotation of the backrest is set to pass through either a midpoint of a line segment connecting two shoulder blades or a fourth thoracic vertebra of the user sitting on the seating portion.

3. The exercise chair according to claim 1, wherein the seating portion is allowed to rotate in roll.

4. The exercise chair according to claim 1, wherein the seating portion is allowed to reciprocate to right and left.

5. The exercise chair according to claim 1, wherein the seating portion is not allowed to rotate in yaw.

6. The exercise chair according to claim 1, further comprising a restraint device configured to restrain a trunk of the user to the backrest.

7. The exercise chair according to claim 1, wherein the support mechanism includes a restoring device configured to return the backrest to a neutral position.

8. A lower extremity exercise system, comprising:
the exercise chair according to claim 1; and
a lower extremity exercise device.

9. The lower extremity exercise system according to claim 8, wherein the lower extremity exercise device is an exercise device configured to at least apply a load for extension and flexion exercises of hip and knee joints of the user.

10. The lower extremity exercise system according to claim 9, wherein the lower extremity exercise device is a pedal exercise device or a stepper exercise device.
